(19) United States
(12) Patent Application Publication
(10) Pub. No.: US 2009/0235085 A1
(43) Pub. Date: Sep. 17, 2009

(54) Method and System for Secure Authentication and Data Exchange in Client Server Architecture

(76) Inventor: Seemant Shankar Mathur, New Delhi (IN)

Correspondence Address: VENABLE LLP, P.O. BOX 34385, WASHINGTON, DC, 20043-9998, US

(21) Appl. No.: 11/795,416

(22) PCT Filed: Jan. 17, 2006
(86) PCT No.: PCT/IN2006/000013

§ 371 Date: Dec. 2, 2008

(30) Foreign Application Priority Data
Jan. 17, 2005 (IN) 105/DEL/2005

(51) Int. Cl. H04L 9/32; G06F 21/00

(52) U.S. Cl. 713/186; 726/5; 713/184

(57) ABSTRACT

The present invention relates to a method for secure authentication and data exchange, in client server architecture, comprising: registering a user and creating a first tabular data using the user's password for authentication of the user, at a server machine, deleting the password in its original form from the server, said server processing said first tabular data and generating a second tabular data to be sent to the client machine when said user logs in for a transaction at the client machine, said server initialing a communication session with the user using said second tabular data and generating a first set of numbers to be used for decryption by the server, encrypting and transferring said second tabular data to said user at the client machine, said client machine generating a second set of numbers to be used for encryption, using said second tabular data, said client encrypting the plain text using said second set of numbers, in a loop for a predetermined number of iterations, said client transmitting the encrypted data to the server, said server performing a decryption on the encrypted text using said first set of numbers, said server authenticating the user in the event correct plain text is generated, and said server completing the transaction.

### FIELD OF THE INVENTION

The present invention belongs to a method and system for Secure Authentication and Data exchange in Client Server Architecture. More particularly it relates to a field of digital data communication and data exchange in client server architecture.

### BACKGROUND OF THE INVENTION

Employees round the world demand more mobility in the industry's connectivity. They want constant connectivity while carrying their notebook from one place to the other. One solution to this is wireless fidelity. This is slowly becoming a part of the standard equipment's list of the PC.

Being unwired has its own set of disadvantages. Since there is no physical medium, information can be tapped effortlessly. Accordingly a robust security infrastructure needs to be in place.

Wireless technology uses authentication protocols that can be easily exploited by hackers. This is largely on account of their architecture, wherein, either the password is stored in the server in some form or the other or the password travels through the connecting medium in some form. Hackers have been able to penetrate these processes while they are being executed and in turn acquire the password and hack into the user's private data.

There is an intense effort, globally, to overcome these shortcomings. Example: A few large companies (VISA, IBM, etc.) have been working together for a while on a technology known as SET (Secure Electronic Transaction). This technology adds a password to your online credit card transaction and secures it via the user's private key. The problem here stands with the fact that the private and public keys travel through the connecting media (In many cases the telephone lines you use to connect to your ISP with.), sometimes using (weak) encryption giving an open invitation to the neighborhood eavesdropper (People who tap the connecting media and acquire information) to acquire them in transit and use them.

Some banks like American Express and ABN-AMRO have also come out with credit cards that have an embedded chip containing the user's private keys, a.k.a. smart cards. The technology, although pretty secure, requires a special hardware device known as a smart card reader. This reader is a bulky piece of equipment and inconvenient to carry. This renders your credit card practically inaccessible in places where the smart card reader is not available.

VISA, The Credit Card Agency and Europay have been working on a specification set called the EMV for a long time. EMV has been finalized and released March 2003 and has contains the standardized specifications of the structure of the smart card as well as data transfer. The EMV has also mandated the transfer of all magnetic strip based cards to smart card infrastructure by the end of 2006 worldwide. This mandates all their 33,000 member banks worldwide to call back all their magstripe cards and convert them to smart cards. What EMV is also providing is a provision in which each of the members banks can use any card authentication mechanism they choose. They have also not ruled out the option of third party card authentication providers (in forms of MSS, Managed Secure Services) to outsource the card security to these companies who will authenticate and authorize all cards and transactions on behalf of the bank. This has suddenly opened a completely new market, which need which has to be catered to immediately.

These examples are specific to the banking and financial services industry, but similar requirements of security exist in all domains where remote access and services need to be provided.

Security is a fast paced market and it is the basic requirement behind interchange of information, which hold any value to the communicating entities. A lot of loopholes are exploited by malicious users using tools available abundantly over the users using tools available abundantly over the Internet. Although security market is widespread, it is more or less controlled by around 5-6 major players or technology providers. Most of the other companies claiming to be security providers merely assemble technologies available in the market and package them without any substantial alterations.

An optimal solution that matches the security requirements, is easy to implement and cost-effective to execute—the guiding principles of the company—has not been delivered yet.

### OBJECTS OF THE PRESENT INVENTION

It is an object of the present invention to overcome the above drawbacks of the prior art and provide method and system for secure authentication and data exchange in client server architecture.

It is another object of the instant invention to provide for a robust mechanism for authentication and data exchange in client server architecture.

It is a further object of the present invention to provide increased security mechanism using a short length key.

It is yet another object of the present invention to provide authentication for the client as well as the server simultaneously.

It is still another object of the present invention to provide a strict user rights management.

It is yet another object of the instant invention to target the maximum number of communication devices.

It is yet another object of the present invention to implement a secure mechanism with the minimal cost.

### BRIEF DESCRIPTION OF THE ACCOMPANYING DRAWINGS

FIG. 1 illustrates a system for the instant invention.

FIG. 2 illustrates a method for carrying out the present invention.

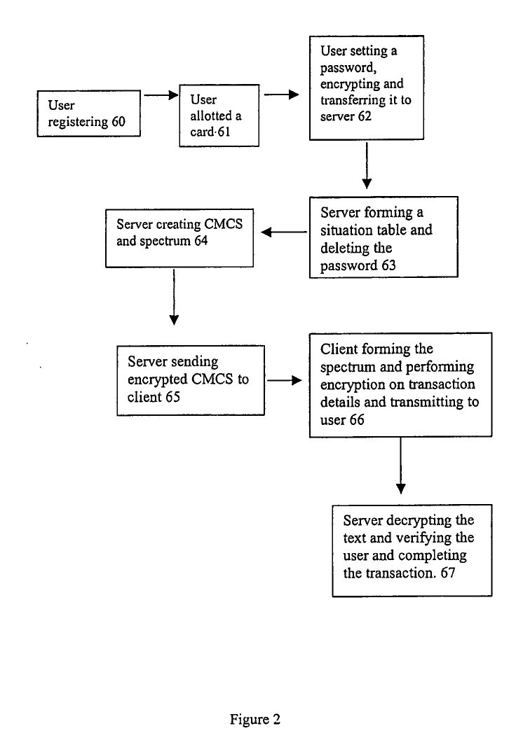

The instant invention provides a method for secure authentication and data exchange, in client server architecture, comprising registering a user and creating a first tabular data using the user's password for authentication of the user, at a server machine, deleting the password in its original form from said server, said server processing said first tabular data and generating a second tabular data when said user logs in for a transaction at a client machine, said server initiating a communication session with the user using said second tabular data and generating a first spectrum, transferring said second tabular data to said user at the client machine, said client machine generating a second spectrum using said second tabular data, said client encrypting the plain text using said second spectrum in a loop for a predetermined number of iterations, said client transmitting the encrypted data to the server, said server performing a decryption on the encrypted text using said first spectrum, said server authenticating the user in the event correct plain text is generated, and said server completing the transaction.

Further, the invention provides a system for secure authentication and data exchange in client server architecture, said system comprising a chip based card allotted to the user, a client machine for registering the user and setting the password, encrypting means in said chip based card for encrypting the password, a server machine for processing the password and storing the password in the form of tabular data, a logging in machine for the user to log in and send username to the server, said server comprising means to generate a first spectrum, said client and card comprising means to generate a second spectrum, said card and server comprising means to encrypt data, data transmitting means for transmitting encrypted text between the client and the server, and means at the server to verify the plain text.

### DETAILED DESCRIPTION

The instant invention is a dynamic encryption mechanism, i.e. it changes the way the information is encrypted for each transaction. Current encryption technologies work with only on one dimension i.e. the only axis within the complete encryption process is the encryption key that is encrypting the information. However the present information divides the complete information into blocks of various sizes, known as proximities, and then uses different keys on each of those blocks. Accordingly, for decryption one would need knowledge of the key used as well as the proximity in which the key was used. The keys and proximity would be different for each session.

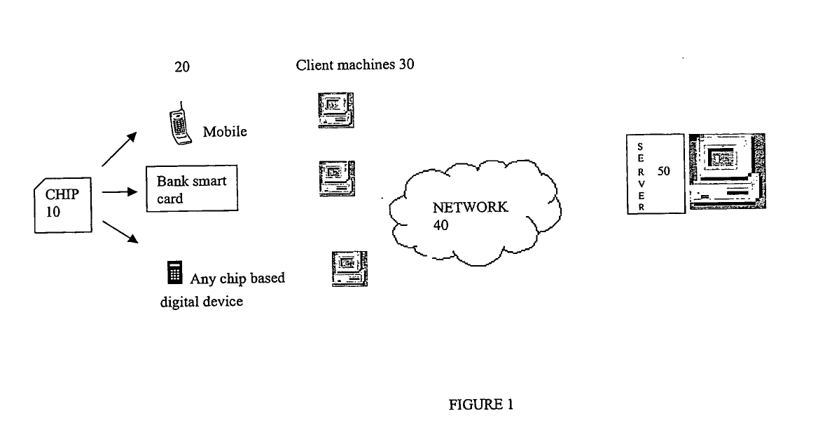

FIG. 1 describes the system for the instant invention. The instant invention can be carried out for the security of the transactions including bank ATMs transactions, transactions through mobile any such transactions through a digital device involving client server architecture.

The user gets a chip based smart card (10), which has stored in it various parameters used for encryption. The chip based card may be of any of the digital applications including bank smart cards and mobile SIM cards (20). The chip card for the mobile would be like the SIM, which contains the new connection number along with the other parameters. However, the user will have to register for a password to be used for encryption and authenticating the user for any transaction. So the user would go to a client machine (30) installed at convenient places or as per the registering authorities' decision. The client machines interact with a server machine (50) through any known networking medium (40). The chip based card has means in it to encrypt the password using the current invention and send it to the server through the networking means. The server has means to manipulate the password and store it in a modified form, which is used for further encryption.

Initializing with the process, a user would first need to be registered (60) with the server so that he can be given the credentials that would be needed to authenticate and encrypt all subsequent transmissions.

An embodiment of this invention can be used for m-commerce. The instant invention would be explained with the help of this embodiment though it can be applicable in any of the digital and embedded technology using client server architecture.

A user goes for a new mobile connection and gets a SIM card (61). According to the instant invention, the SIM card being a chip based card would contain, in addition to the new connection, the following:

i. a Universal Identification Number (UID),

ii. a Personality table,

iii. a Current Mood table,

iv. user's Key Chain, and

v. initial spectrum.

UID is a unique number granted to each SIM card. It identifies the user's username, country of origin and bank.

Personality Table is a reference table, which is assigned to each user. The personality table resembles a conversion table which has a numeric representation of all characters from A →Z, a→z, 1→0, and the character period (.). It is to be observed that the allocated value should be a non-repeating number preferably from 79 to 141. An example of one such personality is shown in Table 1.

It is not necessary that each user will have a unique personality but the likelihood of a personality repeating itself will be after 3*10⁸⁵ users. Taking one character to be 1 byte in size and given the fact that the numbers 79 to 141 lie within the unsigned short range, which, in turn, occupies 2 bytes of memory; the complete table would be 186 bytes in length.

TABLE 1

| | |
|---|---|
| A | 136 |
| B | 140 |
| C | 137 |
| D | 88 |
| E | 135 |
| F | 99 |
| G | 109 |
| H | 116 |
| I | 101 |
| J | 124 |
| K | 134 |
| L | 79 |
| M | 115 |
| N | 138 |
| O | 125 |
| P | 130 |
| Q | 98 |
| R | 132 |
| S | 126 |
| T | 108 |
| U | 133 |
| V | 127 |
| W | 97 |
| X | 139 |
| Y | 114 |
| Z | 131 |
| a | 128 |
| b | 90 |
| c | 105 |
| d | 117 |
| e | 123 |
| f | 89 |
| g | 110 |
| h | 93 |
| i | 81 |
| j | 82 |
| k | 100 |
| l | 80 |
| m | 102 |
| n | 111 |
| o | 94 |
| p | 106 |
| q | 121 |
| r | 83 |
| s | 112 |
| t | 95 |
| u | 107 |
| v | 84 |
| w | 122 |
| x | 96 |
| y | 113 |
| z | 85 |
| 1 | 119 |
| 2 | 91 |
| 3 | 118 |
| 4 | 86 |
| 5 | 103 |
| 6 | 87 |
| 7 | 120 |
| 8 | 92 |
| 9 | 104 |
| 0 | 129 |
| . | 141 |

Current mood is a dynamic entity. Table 2 shows an example of mood table. It shall be explained later.

TABLE 2

| Scenario | Product Style |
|---|---|
| 00 | → |
| 01 | 3→ |
| 10 | ←2 |
| 11 | ← |

User's key chain contains ten 8-bit keys used to encrypt all subsequent information between the client and the server. The bit length is modifiable.

The SIM card chip programmed with the above is allotted to registered user. The issuing authority will also include in the card an initial spectrum (proximity+Keys).

The user will then set a password of his choice (62), which will decide how his data is to be encrypted for a session. The password setting can be done at any of the ATMs or any such outlet established by the registering authority.

In one embodiment, only capital letters, small case letters, numbers and the period (.) should constitute the password (A→Z, a→z, 1→0, or period). The period character is, generally, the most conveniently type able character in cell phones.

The password set by the user is encrypted using the initial spectrum and then sent to the server. The registration stage is the only time the password will travel through the network in an encrypted state decided by the initial spectrum present on the card when it is issued.

Once the desired password reaches the server, the following steps are carried out:
1) The user's corresponding Situation Table is generated.
2) The next mood table is randomly selected from the mood bank and sent to the client. A copy of the associated mood table is also stored in the server.

All instances of the user's password are eliminated from the server's memory (63).

Situation Table is sent to the user for initiating the authentication process. The structure of the Situation Table is shown in Table 3.

TABLE 3

| | | |
|---|---|---|
| | | Sum Of Products |
| Ser. No. | Character Set | (SOPs) |

Situation Table consists of three columns, serial number, character set and sum of products (SOP).

Serial number will contain the serial number of the corresponding row containing the character set and the SOP.

Character Set contains a predetermined number of randomly generated numbers. In one embodiment, each number will have 10 digits. The value of each digit of the character set should not be more than the length of the password. For e.g. if the password is of 5 characters, the character set should have numbers containing digits from 0-5 only. However, the more lengthy the password, the more secure the system. A digit cannot be repeated more than twice in one character set.

For each digit in a character set, the corresponding character from the password is picked and its corresponding value is picked using the personality table.

For e.g. let 2537116890 be one of the character sets contained in the situation table.

Suppose the user's desired password is “ImLovin.IT”. If we divide this password into individual characters and look up the corresponding conversion in the personality table, we will obtain the following as shown in table 4.

TABLE 4

| | Character | | | | | | | | | |
|---|---|---|---|---|---|---|---|---|---|---|
| | I | m | L | o | v | i | n | . | I | T |
| Position | 1 | 2 | 3 | 4 | 5 | 6 | 7 | 8 | 9 | 0 |
| Con- | 101 | 102 | 79 | 94 | 84 | 81 | 111 | 141 | 101 | 108 |
| version | | | | | | | | | | |

The characters of the password having position corresponding to each of the digit of the character set are picked. For e.g. the first digit of the character set is 2, so the character corresponding to position 2 is ‘m’. Similarly, the next digit is 5, so the character corresponding to position 5 from table 4 is ‘v’.

Therefore, for the character set 2537116890 the order of considered characters would be “m, v, L, n, I, I, i, ., I, T”.

Now for each of the considered characters, its conversion is picked from the personality table. The conversions are shown here in table 4 for this example. Pairs are made and they are multiplied and the products are then summed up.

The conversions for the above-considered characters would be 102 84 79 111 101 101 81 141 101 108

Now making pairs, multiplying them and summing them up would be

(102*84)+(79*111)+(101*101)+(81*141)+(101*108) or, (8568)+(8769)+(10201)+(11421)+(10908)49867

So 49867 is the SOP for the character set 2537116890.

Similarly character set is calculated for all the character sets of the situation table.

This concludes the registration session of a user. The password sent by the user is then deleted from the server.

Once the registration is done, the user is ready for any secured transaction session through the instant invention. The method for a secured transaction without any password to authenticate the user is explained now.

The user's password has been deleted from the server. However the server has the situation table.

The user initiates the authentication process by sending a login request to the server. In one embodiment, the login request may be initiated by the server. The user's username i.e. the UID is sent to the server along with the request and a header which contains the information that whether the request is for a fresh registration or a transaction request. The server fetches the corresponding situation table for the user.

The server then randomly generates six numbers between 1 and n where n is the number of entries in the situation table i.e. the last serial number. The number of entries in the situation table is configurable. The server will then fetch the character sets from the situation table whose serial number corresponds to the randomly generated six numbers. Accordingly, we will have six character sets fetched from the situation table.

In order to decide where the proximities lie and which keys are going to be used to encrypt them, the server generates Critical Mass Character Set (CMCS) (64).

CMCS are a pair of character sets, which, combined, consider all characters of the password.

The generation of CMCS is explained with the following example.

Let us consider the following character sets.

2537116890←The Number “4” is not a part of this character set.

So we perform a linear search for a character set that has 4 in it starting from the present character set.

1563881.932←The Number “4” is a part of this character set.

Now we have all the digits in the combination of the two character sets. This is the CMCS. So for the six character sets fetched from the situation table, we will have twelve characters i.e. six pairs or six CMCSs.

Once the CMCS are extracted, the server will initiate a communication session with the client. The server will extract the SOPs of the above twelve character sets. This is shown in Table 5.

TABLE 5

| Character Set | SOP |
|---|---|
| 2511748940 | 53596 |
| 4473660051 | 44314 |
| 2283950284 | 46397 |
| 5147663490 | 43813 |
| 5748396758 | 51392 |
| 6837198600 | 53476 |
| 1758299657 | 50862 |
| 6748210799 | 54736 |
| 1966092852 | 50620 |
| 5637212883 | 51396 |
| 7281096837 | 56661 |
| 3893567244 | 46080 |

We will now use the Mood Table shown in table 2. The first CMCS in the above table 5 is 2511748940 & 4473660051 whose respective SOPs are 53596 & 44314. The server multiplies these SOPs together according to the mood table. The mood provides the method by which the SOPs would be multiplied.

The server refers to the Least Significant Digit (LSD) of the individual SOPs. For 53596 the LSD is “6” and for 44314 the LSD is “4”. In table 2, the first column denotes the scenario of the LSDs of the SOPs corresponding to the CMCS. An “Even” LSD is denoted by a “0” and an “Odd” LSD is denoted by a “1”. Hence if the LSDs of both the SOPs are even then they are denoted by “00” and if they are both odd then they are denoted by “11” in case any one is odd then they are denoted by a “10” or “01” accordingly.

The second column of the mood denotes the Product Style. The product style is the arrangement of the second SOP before they are multiplied together. The second column contains a number followed by a forward or backward arrow. The number represents the numeric position to the left of the LSD. In case there is no number mentioned then transformation of the second SOP is initiated by the LSD itself. The SOP is then rotated clockwise or anticlockwise depending on forward or backward arrow respectively.

Accordingly, if the product style says ←2, it means that we move two digits to the left of the second SOP and then rotate the SOP anticlockwise starting from the new digit.

The first CMCS in table 5 is 2511748940 & 4473660051; their respective SOPs being 53596 & 44314. The LSD of the two SOPs is respectively 6 and 4. Accordingly the scenario is 00. The product style according to the scenario 00 in table 2 is “→”. This means that the new second SOP would start from the present LSD i.e. 4. Rotating the SOP clockwise once, we get 44431. Accordingly 53596 will be multiplied by 44431.

Other examples to clearly understand the procedure are shown in Table 6.

TABLE 6

| | Example | | New |
|---|---|---|---|
| Scenario | SOPs | Style | Operands |
| 00 | 34522, 23450 | → | 34522 * 02345 |
| 01 | 51338, 32879 | 3→ | 51338 * 28793 |
| 10 | 44691, 32456 | ←2 | 44691 * 42365 |
| 11 | 27877, 43719 | ← | 27877 * 91734 |

The above obtained operands are multiplied together to derive the product. Two such products make a Spectrum.

The Spectrum denotes the proximities the plain text is divided into, as well as, the keys, which are going to be used on the proximities to encrypt the plain text.

Let's take the 1^{st} and the 2^{nd} CMCSs (2511748940 & 4473660051, 2283950284 & 5147663490) from table 5. Their respective SOPs are 53596 & 44314, 46397 & 43813. And hence their products become, (53596*44431=2381323876, 46397*31834=1477002098). The first obtained product (2381323876) denotes the proximities of the plaintext and the second obtained product (1477002098) denotes the serial number of the 10 keys that will encrypt the corresponding proximity of the plaintext.

Observing generated Spectrum (2381323876, 1477002098) the encryption/decryption would be brought about by the following steps:
1) The server will form 10 blocks in its memory (Each block should preferably be a two dimensional array containing one column and rows adjustable to the length of the information that needs to be encrypted. Each field should accommodate 10 characters.)
2) The arrays will be populated according to the proximities decided by the current spectrum . . .
   First 2 bytes will be stored in Block 1 row 1;
   Next 3 bytes will be stored in Block 2 row 1;
   Next 8 bytes will be stored in Block 3 row 1;
   Next 1 byte will be stored in Block 4 row 1;
   Next 3 bytes will be stored in Block 5 row 1;
   Next 2 bytes will be stored in Block 6 row 1;
   Next 3 bytes will be stored in Block 7 row 1;
   Next 8 bytes will be stored in Block 8 row 1;
   Next 7 bytes will be stored in Block 9 row 1;
   Next 6 bytes will be stored in Block 10 row 1;
   Moving cyclically,
   The next 2 bytes will be stored in Block 1 row 2;
   Next 3 bytes will be stored in Block 2 row 2;
   Next 8 bytes will be stored in Block 3 row 2;
   Next 1 byte will be stored in Block 4 row 2;
   Next 3 bytes will be stored in Block 5 row 2;
   Next 2 bytes will be stored in Block 6 row 2;
   Next 3 bytes will be stored in Block 7 row 2;
   Next 8 bytes will be stored in Block 8 row 2;
   Next 7 bytes will be stored in Block 9 row 2;
   Next 6 bytes will be stored in Block 10 row 2;
3) This cycle will continue till the EOM (End of Message) is reached. In case the number of characters left in the message is lesser than the number of characters needed to be considered according to the proximity, the remaining characters are stored in the designated block regardless of the length.
4) The characters of each block are concatenated together and then encrypted by the corresponding key.

For e.g. in the above example, the proximities and keys are decided as follows:

(B1[Row 1]+B1[Row 2]+B1[Row 3]+B1[Row 4] . . . ) is encrypted by key # 1
(B2[Row 1]+B2[Row 2]+B2[Row 3]+B2[Row 4] . . . ) is encrypted by key # 4
(B3[Row 1]+B3[Row 2]+B3[Row 3]+B3[Row 4] . . . ) is encrypted by key # 7
(B4[Row 1]+B4[Row 2]+B4[Row 3]+B4[Row 4] . . . ) is encrypted by key # 7
(B5[Row 1]+B5[Row 2]+B5[Row 3]+B5[Row 4] . . . ) is encrypted by key # 0
(B6[Row 1]+B6[Row 2]+B6[Row 3]+B6[Row 4] . . . ) is encrypted by key # 0
(B7[Row 1]+B7[Row 2]+B7[Row 3]+B7[Row 4] . . . ) is encrypted by key # 2
(B8[Row 1]+B8[Row 2]+B8[Row 3]+B8[Row 4] . . . ) is encrypted by key # 0
(B9[Row 1]+B9[Row 2]+B9[Row 3]+B9[Row 4] . . . ) is encrypted by key # 9
(B10[Row 1]+B10[Row 2]+B10[Row 3]+B10[Row 4] . . . ) is encrypted by key #8
‘+’ stands for concatenation.
5) The individual cipher texts are then divided into their various proximities and stored back in same rows they were initially concatenated from.
6) Finally the complete cipher texts are concatenated to form a single stream of cipher text. In other words . . .

### B1[Row 1]+B2[Row 1]+B3[Row 1]+ . . . +B10[Row 1]+B1[Row 2]+B2[Row 2]+ . . . +B10[Row 4]

7) In one embodiment, the cipher text is encrypted 2 more times (in our examples we are generating 3 spectrums hence the plain text will undergo 3 passes from the engine to render the final cipher).

After the above the concatenated and encrypted CMCS is sent to client (65). The CMCS transmitted to the client for authentication are collectively known as a “Situation”.

The client receives the above CMCS and calculates the spectrum in the same way as above.

Now the user starts with the transaction. The information would be encrypted using the spectrum (66). This encryption is carried out inside the card.

Ten 8-bit keys are taken from the key chain stored in the user's card.

Assume that the 10, 8-bit keys are:

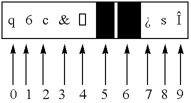

| | | | | |
|---|---|---|---|---|
| CMCS: | 2511748940 | 4473660051 | 2283950284 | 5147663490 |
| SOPs: | 53596 | 44314 | 46397 | 43813 |

| Spectrum: | Proximity | Keys |
|---|---|---|
| | 2381323876 | 1477002098 |

According to the method described above, first 2 bytes are stored in block 1, row 1; next 3 bytes are stored in block 2 row 1 and so on.

The concatenated data of block 1 row 1, block 1 row 2 and so on is encrypted using key 1 i.e. ‘q’ using any known encryption technique.

This is loop 1. The cipher text out of this loop is again encrypted using the next spectrum. More the number of loops, more secure the encryption. In case, in the next loop, a proximity is to be encrypted using the same key as the previous, the next key is used. Else, it would result in decryption of the text.

The obtained individual ciphers are recombined and sent to the receiving entity.

The encrypted text is sent to the server. The server will receive the incoming cipher text from the client and then run the encryption process backwards to render the plain text (67). Key is given to server at time of registration. It remains unique.

The server will use the last spectrum first in the same way as for encryption process and continue thus decrypting the text.

The thus obtained plain text will authenticate the user. Once the identity is confirmed, the acquiring agency will perform the necessary transactions the way the credit card company currently does. In case the hence produced plain-text does not match the required format and syntax, or, if the server does not successfully decrypt the ciphertext to its corresponding plaintext, then it is obvious that there is a mismatch between the spectrums generated by the server (used for decrypting) and the ones the client generated to encrypt the plaintext. A mismatch in the spectrum implies that the user is not authentic. A mismatch could result from any one of more of the following:

Wrong Token.

Wrong Password

Wrong Mood

The user can be given a few number of more trials which is configurable.

amount of security even when small keys are used. Small keys ensure faster encryption/decryption.

It will readily be appreciated by those skilled in the art that the present invention is not limited to the specific embodiments shown herein. Thus variations may be made within the scope and spirit of the accompanying claims without sacrificing the principal advantages of the invention.

1. A method for secure authentication and data exchange, in client server architecture, comprising:
registering a user and creating a first tabular data using the user's password for authentication of the user, at a server machine,
deleting the password in its original form from the server,
said server processing said first tabular data and generating a second tabular data to be sent to the client machine when said user logs in for a transaction at the client machine,
said server initiating a communication session with the user using said second tabular data and generating a first set of numbers to be used for decryption by the server,
encrypting and transferring said second tabular data to said user at the client machine,
said client machine generating a second set of numbers to be used for encryption, using said second tabular data,
said client encrypting the plain text using said second set of numbers, in a loop for a predetermined number of iterations,
said client transmitting the encrypted data to the server,
said server performing a decryption on the encrypted text using said first set of numbers,
said server authenticating the user in the event correct plain text is generated, and
said server completing the transaction.

2. The method as claimed in claim 1, wherein said registering said user comprises:
allotting a chip based card to said user, said card having stored, a universal identification number (UID),
a personality table,
a current mood table,
user's key chain, and
initial spectrum.

3. The method as claimed in claim 2, wherein said universal identification number comprises said user's details including the username, user's nationality and user's bank.

4. The method as claimed in claim 2, wherein said personality table is a conversion table having numeric equivalents of all characters said characters from A→Z, a→z, 1→0, and the character period (.).

5. The method as claimed in claim 2, wherein said mood table is used for creating said second tabular data.

6. The method as claimed in claim 2, wherein said key chain and initial spectrum is used for said encryption.

7. The method as claimed in claim 1, wherein said user sets a password during registration, at the client machine, and said password is transmitted to said server machine in an encrypted state, said encryption being done using said initial spectrum.

8. The method as claimed in claim 1, wherein said first tabular data at the server comprises:
serial number,
character set, and
sum of products.

9. The method as claimed in claim 8, wherein said character set contains random number.

10. The method as claimed in claim 1, wherein generating said first tabular data comprises:
generating a predetermined number of random numbers for the character set, each digit of said random numbers not being more than the length of the password,
for each character set, picking the characters of the password which have the face value equal to the digits of the character set,
forming pairs of numeric equivalents of said picked characters of the password, said equivalents being fetched from said personality table,
summing the product of said pairs.

11. The method as claimed in claim 1, wherein said server fetches the corresponding first tabular data when a user logs in for transaction and swipes the chip based card, sending his user name to the server.

12. The method as claimed in claim 2, wherein said second tabular data comprises a critical mass character set (CMCS).

13. The method as claimed in claim 12, wherein generation of CMCS comprises:
randomly generating numbers having values between 1 and the total entries in the first tabular data,
fetching first bunch of character sets from said first tabular data corresponding to the serial number equal to said random numbers,
for each of the character sets in said first bunch, linearly searching and fetching a second character set from said first tabular data, which has the digit not present in the character set of the first bunch, said search being done on character sets starting from the character set in the first bunch, and
forming pairs of such character set.

14. The method as claimed in claim 13, wherein initiating a communication session comprises:
fetching the sum of products corresponding to each of the character sets in the CMCS,
fetching the corresponding sum of products from the first tabular data,
identifying the least significant digit (LSD) for each of the sum of products of each CMCS,
fetching the style of multiplication from the mood table, the mood table comprising the style of multiplication depending on scenario of the least significant digits, and
multiplying the sum of products according to the style fetched from the mood table.

15. The method as claimed in claim 14, wherein the mood table comprises:
scenario in the mood table, said scenarios selected from one of
the LSD of first SOP even and second SOP odd,
the LSD of first SOP even and second SOP even,
the LSD of first SOP odd and second SOP odd, and
the LSD of first SOP odd and second SOP even.
product style.

16. The method as claimed in claim 15, wherein said product style comprises rotating the second SOP from the position accordingly as defined in the mood table.

17. The method as claimed in claim 14, wherein two said products form a spectrum, one product of said spectrum being used for dividing the plain text and one product being used for deciding the key for encryption.

18. The method as claimed in claim 1, wherein the memory at the server is divided into a predetermined number of blocks, each block having one column and a configurable number of rows.

19. The method as claimed in claim 17, wherein the digits of said first product determines the total bytes of data to be stored in each row of each block.

20. The method as claimed in claim 19 wherein said data is stored block wise in a row, subsequent data being stored cyclically block wise in the next row.

21. The method as claimed in claim 20, wherein data from all the rows of each block are concatenated block wise and encrypted by one key.

22. The method as claimed in claim 21, wherein the encrypted and concatenated complete CMCS is sent to the user at the client machine.

23. The method as claimed in claim 1, wherein generating a second spectrum by the user comprises steps as explained in previous claims.

24. The method as claimed in claim 20, wherein said encrypting the text comprises:
dividing said key-chain into subkeys of the size of the length of the password,
breaking the plain text into blocks
concatenating and encrypting the text of all the rows of each block using the corresponding key,
concatenating the encrypted text and breaking again as explained in a loop for as many times as the number of CMCS,

25. The method as claimed in claim 1, wherein said decryption by server comprises reverse encryption.

26. A system for secure authentication and data exchange in client server architecture, said system comprising:
a chip based card allotted to the user,
means at the client end for registering the user and setting the password,
encrypting means in said chip based card for encrypting the password,
means at the server end for processing the password and storing the password in the form of tabular data,
a logging in machine for the user to log in and send username to the server end,
said server comprising means to generate a first set of numbers for use in decryption,
said client and card comprising means to generate a second set of numbers for use in encryption,
said card and server comprising means to encrypt and decrypt data,
data transmitting means for transmitting encrypted text between the client and the server, and
means at the server to verify the plain text.

27. A computer program product stored on a computer readable medium for secure authentication and data exchange in client server architecture, comprising computer readable program code means configured for:
registering a user and creating a first tabular data using the user's password for authentication of the user, at a server machine,
deleting the password in its original form from the server,
said server processing said first tabular data and generating a second tabular data to be sent to the client machine when said user logs in for a transaction at the client machine,
said server initiating a communication session with the user using said second tabular data and generating a first set of numbers to be used for decryption by the server,
encrypting and transferring said second tabular data to said user at the client machine,
said client machine generating a second set of numbers to be used for encryption, using said second tabular data,
said client encrypting the plain text using said second set of numbers, in a loop for a predetermined number of iterations,
said client transmitting the encrypted data to the server,
said server performing a decryption on the encrypted text using said first set of numbers,
said server authenticating the user in the event correct plain text is generated, and
said server completing the transaction.

28. A computer program product comprising computer readable program code means configured for configuring the system as claimed in claim 26, to optimize the performance and achieve the desired result.
